(19) United States
(12) Patent Application Publication
(10) Pub. No.: US 2026/0274346 A1
(43) Pub. Date: Sep. 17, 2026

(54) FRONT VEHICLE BODY STRUCTURE

(71) Applicants: Hyundai Motor Company, Seoul (KR); Kia Corporation, Seoul (KR)

(72) Inventor: Do Hoi KIM, Hwaseong-Si (KR)

(21) Appl. No.: 19/330,164

(22) Filed: Sep. 16, 2025

(30) Foreign Application Priority Data
Mar. 11, 2025 (KR) 10-2025-0031693

(51) Int. Cl. B62D 25/14; B62D 25/08

(52) U.S. Cl. CPC B62D 25/14; B62D 25/085

(57) ABSTRACT

A front vehicle body structure may include a front side member arranged along a front-rear direction of the vehicle body on both sides according to a vehicle width direction; a fender apron member connected to each of the front side members; and an integrated casting member joined to the front side member and the fender apron member, wherein the dash panel and the front cowl are formed in one body.

### CROSS-REFERENCE TO RELATED APPLICATION

This application claims priority to and the benefit of Korean Patent Application No. 10-2025-0031693, filed with the Korean Intellectual Property Office on Mar. 11, 2025, the entire contents of which are incorporated herein by reference.

### TECHNICAL FIELD

The present disclosure relates to a front body structure of a vehicle, and more particularly, to a front body structure having an improved dash structure at the front of the vehicle body.

### BACKGROUND

A structure for coping with a reduction in weight of a vehicle body may improve fuel economy of a vehicle. For example, it may be desirable for a vehicle body structure to be capable of improving strength and rigidity while implementing a reduction in weight and satisfying regulations that have become strict in vehicle industries.

Typically, the front body has front side members on both sides, fender apron members respectively joined to the front side members on both sides, and a dash panel joined to the front side members and the fender apron members.

Additionally, the front body has a front cowl member that is connected to the upper portion of the dash panel to support a front glass and is joined to the fender apron member.

The front body may have a monocoque structure in which parts such as panels and frames are connected by a spot welding, etc.

In such a front body structure, securing the strength of the connection between the parts is of utmost importance. However, if the front body structure requires the plurality of parts that are joined to each other and separate reinforcing parts to reinforce the front frame rigidity, the number of parts, weight, and manufacturing cost of the vehicle body increase, and there is a limit to increasing the front collision rigidity.

The above information disclosed in this Background section is only for enhancement of understanding of the background of the disclosure and therefore it may contain information that does not form the prior art that is already known in this country to a person of ordinary skill in the art.

### SUMMARY

The following summary presents a simplified summary of certain features. The summary is not an extensive overview and is not intended to identify key or critical elements.

Systems, apparatuses, and methods are described for a front vehicle body structure and/or a vehicle comprising the same. A front vehicle body structure of a vehicle body may comprise a pair of front sides extending along a front-rear direction of the vehicle body and positioned on both sides of the front vehicle body structure in a vehicle width direction; a pair of fender aprons, wherein each fender apron of the pair of fender aprons is connected to a corresponding front side of the pair of front sides; and an integrated casting body comprising a dash panel and front cowl formed integrally, wherein the integrated casting body is joined to the front sides and the fender aprons.

A front vehicle body structure may also, or alternatively, comprise an integrated casting body comprising a dash panel and front cowl formed integrally; a pair of front sides extending in a front-rear direction from either side of the integrated casting body in a width direction; and a pair of fender aprons, wherein each fender apron of the pair of fender aprons is attached to a corresponding front side.

A vehicle may comprise a front vehicle body structure as disclosed herein. For example, the vehicle may comprise a front vehicle body structure comprising: a pair of front sides extending along a front-rear direction of the vehicle and positioned on both sides of the front vehicle body structure in a vehicle width direction; a pair of fender aprons, wherein each fender apron of the pair of fender aprons is connected to a corresponding front side of the pair of front sides; and an integrated casting body comprising a dash panel and front cowl formed integrally, wherein the integrated casting body is joined to the front sides and the fender aprons. Also, or alternatively, the vehicle may comprise an integrated casting body comprising a dash panel and front cowl formed integrally; a pair of front sides extending in a front-rear direction from either side of the integrated casting body in a width direction; and a pair of fender aprons, wherein each fender apron of the pair of fender aprons is attached to a corresponding front side.

According to the disclosed front body structure, by applying the relatively large integrated casting member formed by the hyper casting method, the set rigidity and strength of the front frame may be secured while reducing the number of body parts, assembly man-hours, weight, and manufacturing cost.

These and other features and advantages are described in greater detail below.

### BRIEF DESCRIPTION OF THE DRAWINGS

The present disclosure will become more fully understood from the detailed description given hereinbelow and the accompanying drawings, which are given by illustration only, and thus are not limitative of the present disclosure.

FIGS. 1 and 2 are combined perspective views illustrating a front body structure according to a disclosed example.

FIG. 3 is an exploded perspective view illustrating a front body structure according to the disclosed example.

FIGS. 4 and 5 are perspective views illustrating an integrated casting member applied to a front body structure according to the disclosed example.

FIG. 6 is a front view illustrating an integrated casting member applied to a front body structure according to the disclosed example.

FIG. 7 is a rear view illustrating an integrated cast member applied to a front body structure according to the disclosed example.

FIG. 8 is a side view illustrating an integrated cast member applied to a front body structure according to the disclosed example.

FIG. 9 is a cross-sectional view along line A-A of a front body structure according to the disclosed example.

FIG. 10 is a cross-sectional view taken along line B-B of a front body structure according to the disclosed example.

FIG. 11 is a cross-sectional view taken along line C-C of a front body structure according to the disclosed example.

FIG. 12 is a cross-sectional view taken along line D-D of a front body structure according to the disclosed example.

FIG. 13 is a cross-sectional view taken along line E-E of a front body structure according to the disclosed example.

FIG. 14 is a cross-sectional view taken along line F-F of a front body structure according to the disclosed example.

The drawings referenced above are not necessarily drawn to scale and are to be understood as presenting rather simplified representations of various preferred features that illustrate basic principles of the present disclosure. Certain design features of the present disclosure, including, for example, particular dimensions, directions, positions, and shapes will be determined in part by particular intended applications and use environments.

### DETAILED DESCRIPTION

The present disclosure will be described more fully hereinafter with reference to the accompanying drawings, in which examples of the disclosure are shown. As those skilled in the art would realize, the described examples may be modified in various different ways, all without departing from the spirit or scope of the present disclosure.

The terms used herein are for the purpose of describing specific examples only, and are not intended to limit the present disclosure. As used herein, singular forms are intended to also include plural forms, unless the context clearly indicates otherwise.

The terms “comprise” and/or “comprising”, when being used in the present specification, specify the presence of the mentioned features, integers, steps, operations, constituent elements, and/or components, without exclusion of a presence or addition of other features, integers, steps, operations, constituent elements, components, and/or groups.

As used herein, the term “and/or” includes any one or all combinations of the items listed in association therewith.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. “One or more of” is synonymous with “at least one of” herein.

Unless otherwise defined, the terms used herein, including technical or scientific terms, may have meanings generally understood by those skilled in the art to which the present disclosure belongs.

The expression "based on" as used herein is intended to describe one or more factors that influence an act or operation of determining or deciding described in a phrase or sentence including that expression, and this expression does not exclude any additional factors that influence the act or operation of determining or deciding.

The term "coupled" denotes a physical relationship between two components in which components are directly connected to each other or indirectly through one or more intermediary components. Examples of such one or more intermediary components may comprise, for example, welding, self-piercing rivets (SPR), flow drill screws (FDS), structural adhesives, and the like.

The terms “vehicle”, “of a vehicle”, “automobile”, or other similar terms used herein may refer to various vehicles, such as passenger vehicles (e.g., sports cars, sport utility vehicles (SUVs), buses, trucks), commercial vehicles, and the like. The vehicle/automobile may refer to hybrid vehicles, electric vehicles, hybrid electric vehicles, fuel cell electric vehicles, and other alternative fuel vehicles (e.g., vehicles driven by a fuel derived from resources other than petroleum). The vehicle/automobile may refer to manned and/or unmanned (e.g., autonomous driving) vehicles.

Hereinafter, the disclosed examples will be described in detail with reference to the attached drawings.

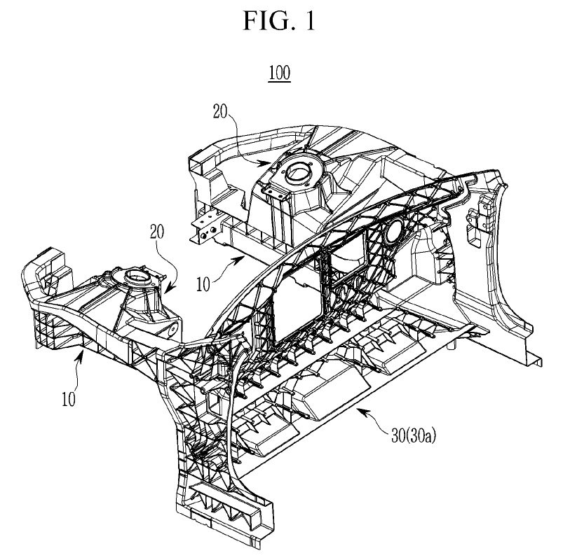

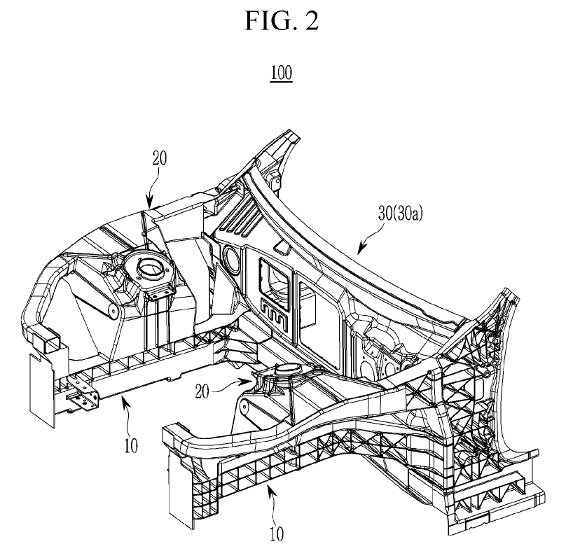

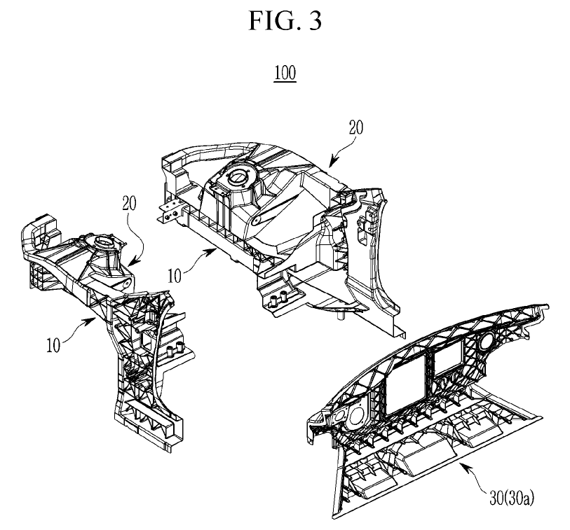

FIGS. 1 and 2 are combined perspective views illustrating a front body structure according to a disclosed example, and FIG. 3 is an exploded perspective view illustrating a front body structure according to the disclosed example.

Referring to FIGS. 1 to 3, the front body structure 100 may be applied to, for example, a vehicle body of an internal combustion engine vehicle and/or a hybrid vehicle having an engine room and a front cabin formed in the front portion.

The front body structure 100 may also, or alternatively, be applied to the vehicle body of an electric vehicle and/or a purpose built vehicle (hereinafter, referred to as 'PBV').

The PBV may be utilized as an electric vehicle-based life module vehicle that provides various customized services to users during the time they travel from a departure point to a destination. The vehicle body of the PBV may be manufactured in various shapes and/or sizes depending on the intended use of the PBV.

The front body structure 100 may be applied to various types of vehicles/PBVs. The various types of the vehicles may include, for example, hailing vehicles as a means of transporting passengers, delivery vehicles for transporting goods, and special vehicles such as ambulances.

In this specification, the reference directions for explaining relative positions of the components below may be referred to as a front-rear direction of the vehicle body (e.g., a vehicle body length direction and/or a longitudinal direction), the width direction (e.g., a left-right direction and/or a lateral direction), and the up-down direction (e.g., a height direction) based on the vehicle body. The reference directions are meant to describe relative positions/orientations of components with respect to a vehicle body, and do not require an absolute orientation of the vehicle body.

Additionally, in this specification, 'an upper end part', 'an upper portion', ‘an upper section’, 'an upper end' or 'an upper surface' of a component refers to an end part, a portion, a section, an end, or a surface of the component that is relatively upper in the drawing. Similarly, 'a lower portion', ‘a lower section’, 'a lower end' or 'a lower surface' of a component represents a portion, a section, an end, or a surface of the component that is relatively lower in the drawing.

“End” (for example, one end, another end, or the like) of a component indicates an end (e.g., edge/end surface) of the component in any direction, and “end portion” (for example, one end portion, another end portion, or the like) of a component indicates a certain part of the component that includes the end.

The front body structure 100 disclosed herein may provide a structure capable of reducing the number of the parts of the vehicle body, assembly man-hours, a weight, and a manufacturing cost while reinforcing the front skeletal rigidity and strength of the vehicle body.

For this purpose, the front body structure 100 (e.g., front vehicle body) according to the disclosed example may include front side members 10 (e.g., side structures of the front vehicle body), fender apron members 20 (e.g., fender aprons), and an integrated casting member 30.

The front side members 10 may be arranged along the front-rear direction of the vehicle body on both sides in the vehicle width direction.

A fender apron member 20 of the fender apron members 20 may be connected to a corresponding of the front side members.

Here, each of the front side member 10 and the fender apron member 20 may be manufactured by assembling panel parts. Also, or alternatively, the front side member 10 and the corresponding fender apron member 20 may be joined by a welding.

The front side member 10 and the fender apron member 20 may be manufactured as an aluminum casting integrally formed by a casting method. Below, the front side member 10 and the fender apron member 20 made of the aluminum casting are described as examples.

In the disclosed example, the integrated casting member 30 may be manufactured by a casting method (e.g., a high pressure casting method) that injects a molten aluminum alloy into a die to form a casting product of a desired shape. That is, the integrated casting member 30 may be provided as an aluminum casting body (30a).

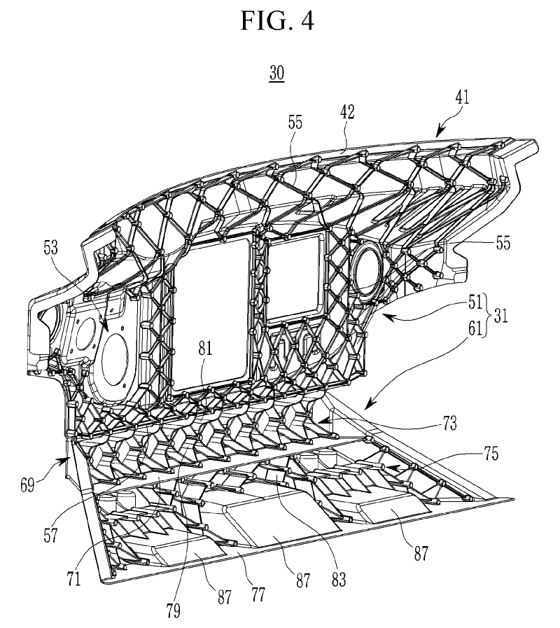

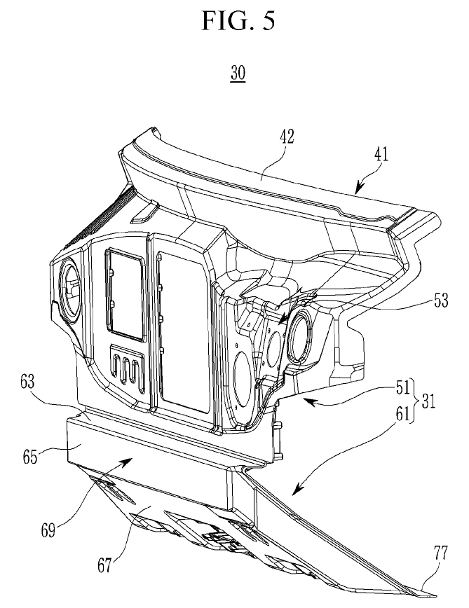

FIGS. 4 and 5 are perspective views illustrating an integrated casting member applied to a front body structure according to the disclosed example.

Referring to FIGS. 4 and 5, the integrated casting member 30 may be provided as an aluminum casting body 30a (referring to FIGS. 1 to 3) in which a dash panel 31 and a front cowl 41 are integrated by a casting method.

The method of forming a relatively large cast product (e.g., the integrated casting member 30) in which the body parts such as the dash panel 31 and the front cowl 41 are integrated in a single casting process may comprise a hyper casting method. Also, or alternatively, this method may comprise and/or be referred to as a mega casting method and/or a giga casting method.

The integrated casting member 30 may be combined with the front side member 10 and the fender apron member 20 (e.g., as shown in FIGS. 1 to 3). For example, the integrated cast member 30 may be joined to the front side member 10 and the fender apron member 20 by a mechanical joining and/or an aluminum welding.

The dash panel 31 of the integrated casting member 30 may be joined to the front part of the floor panel.

The front cowl 41 of the integrated casting member 30 may be connected to the upper portion of the dash panel 31 along the width direction of the vehicle. The front cowl 41 of the integrated casting member 30 may be joined to the upper portion of the fender apron member 20.

The configurations and assembly structure of such integrated casting members 30 will be described in detail later.

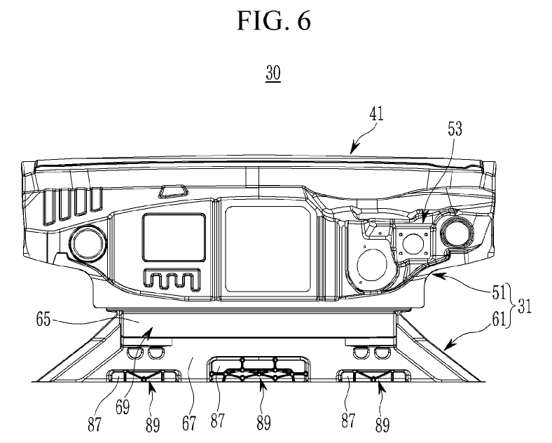

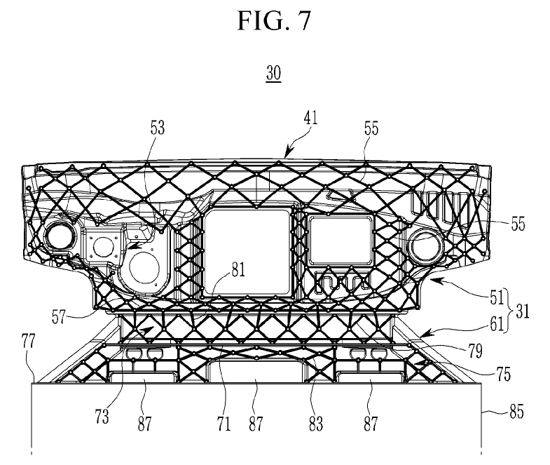

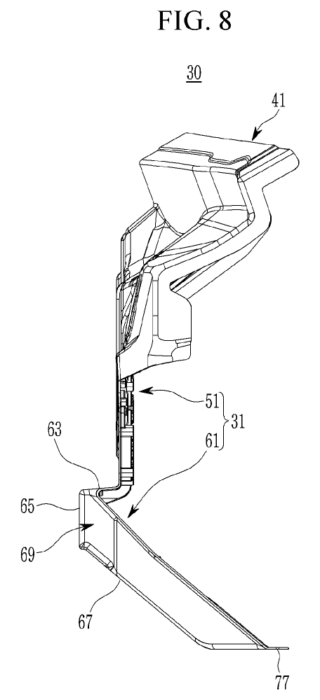

FIG. 6 is a front view illustrating an integrated casting member applied to a front body structure according to the disclosed example, FIG. 7 is a rear view illustrating an integrated casting member applied to a front body structure according to the disclosed example, and FIG. 8 is a side view illustrating an integrated casting member applied to a front body structure according to the disclosed example.

Referring to FIGS. 4 to 8 together with to FIGS. 1 to 3, in the integrated casting member 30 according to the disclosed example, the dash panel 31 may include a dash upper portion 51 (e.g., upper dash) and a dash lower portion 61 (e.g., lower dash).

The dash upper portion 51 may be connected to the front cowl 41 and be joined to the upper portion of the fender apron member 20. The front cowl 41 may be connected along the width direction of the vehicle to the upper portion of the dash upper portion 51.

The dash lower portion 61 may be connected to the lower portion of the dash upper portion 51. The dash lower portion 61 may be joined to the lower portion of the fender apron member 20 and the front side member 10.

The dash upper portion 51 and the dash lower portion 61, and the joint structure of the front cowl 41, the dash upper portion 51, and the dash lower portion 61 to the front side member 10 and the fender apron member 20 may be configured as disclosed herein.

The dash upper portion 51 may include at least one assembly mounting forming section 53 (e.g., at least one assembly mount support).

At least one of the assembly mounting forming sections 53 may be configured to mount (e.g., accept a mount of) dash components/assemblies, such as a brake booster and/or a steering column, to the dash upper portion 51.

At least one assembly mounting forming section 53 may be formed in a shape that protrudes from the front to the rear or from the rear to the front in a set area of the dash upper portion 51.

The casting thickness of at least one of the assembly mounting forming sections 53 may be thicker than the casting thickness of other areas of the dash upper portion 51. The casting thickness of at least one of the assembly mounting forming sections 53 may be determined/selected according to a mounting rigidity required to mount the dash components/assemblies to the dash upper portion 51.

Integrally forming at least one assembly mounting forming section 53 (e.g., having the predetermined set casting thickness and the shape) into the dash upper portion 51 may reduce the number of the mounting components for mounting the dash components/assemblies to the dash upper portion 51.

The rigidity and strength of the dash upper portion 51 of the dash component/assembly mounting may be reinforced by the set casting thickness and shape of at least one assembly mounting forming section 53.

The dash upper portion 51 may further include dash upper reinforcing ribs 55 formed on the rear surface.

The dash upper reinforcing ribs 55 may be designed to reinforce the rigidity and/or strength of the front cowl 41 and the dash upper portion 51 that are connected to each other.

The dash upper reinforcing ribs 55 may be connected to the front cowl 41. The dash upper reinforcing ribs 55 may be formed on a rear surface of the dash upper portion 51 and on a rear surface of the front cowl 41. The dash upper reinforcing ribs 55 may be connected to each other (e.g., interconnected).

For example, the dash upper reinforcing ribs 55 may be provided in a form in which unit ribs formed in an 'X' shape are connected to each other in the width direction and the vertical direction.

The front cowl 41 may include a glass support member 42 (e.g., a windshield support) formed at the upper portion of the integrated casting member 30 (referring to FIGS. 4 and 5). The glass support member 42 may be designed to support a front glass (e.g., windshield, not shown). These glass support member 42 may be connected to the dash upper portion 51 via the dash upper reinforcing ribs 55 (e.g., a 'X' shaped dash upper reinforcing ribs 55).

The dash upper portion 51 may include an upper horizontal reinforcing rib 57 (also referred to as upper transverse reinforcing rib 57) formed along the width direction at the rear lower portion.

The upper transverse reinforcing rib 57 may be designed to reinforce the transverse rigidity of the lower portion of the dash upper portion 51 in the width direction.

The upper horizontal reinforcing rib 57 may be formed to protrude rearward along the width direction at the rear lower portion of the dash upper portion 51.

The dash lower portion 61 may include a first portion 63 extending forward from the lower portion of the dash upper portion 51, a second portion 65 extending downward from the first portion 63, and a third portion 67 extending downwardly and rearwardly from the second portion 65.

Here, the first portion 63, the second portion 65, and the third portion 67 may be combined with the front side member 10 along the width direction. The first portion 63 and the second portion 65 may comprise dash cross sections 69 arranged in the width direction.

The first portion 63, the second portion 65, and the third portion 67 may form a load path configured to absorb and distribute a load (e.g., a collision load) applied to the front of the vehicle body via the front side member 10 along the vehicle width direction. The first portion 63, the second portion 65, and the third portion 67 may reinforce the rigidity and strength of the dash lower portion 61 in response to a frontal collision of the vehicle.

The dash lower portion 61 may include a lower horizontal reinforcing rib 71 formed along the width direction of the vehicle at the rear surface.

The lower transverse reinforcing rib 71 may be designed to reinforce the transverse rigidity of the upper portion of the dash lower portion 61 in the width direction.

The lower horizontal reinforcing rib 71 may be positioned at a set interval from the upper horizontal reinforcing rib 57 of the dash upper portion 51. The lower horizontal reinforcing rib 71 may be formed to protrude rearwardly along the vehicle width direction at the rear upper portion of the dash lower portion 61.

The dash lower portion 61 may include at least two-stage open sections 73 and 75, each divided into opened cross sections in the up-down direction on the rear surface.

The at least two-stage open sections 73 and 75 may be designed to reinforce the rigidity and strength of the dash lower portion 61 against the frontal collision of the vehicle.

The at least two-stage open sections 73 and 75 may form a load path that absorbs and distributes the collision load input to the front of the vehicle body through the front side member 10 in the up-down direction when the vehicle collides in the front.

The at least two-stage open sections 73 and 75 may, according to an example, include an upper open section 73 connected to the dash upper section 51 in the dash lower section 61, and a lower open section 75 connected to the upper open section 73.

The drawings depict the at least two-stage open sections 73 and 75 as being the upper open section 73 and the lower open section 75, but the disclosure is not limited thereto. For example, depending on the rigidity and strength of the dash lower portion 61 required/desired to absorb and distribute the front collision load, the dash lower portion 61 may be provided with one open section and/or three or more multi-stage open sections.

The upper open section 73 may be formed between the upper horizontal reinforcing rib 57 and the lower horizontal reinforcing rib 71. The lower open section 75 may be formed between the lower portion 77 of the dash lower portion 61 and the lower horizontal reinforcing rib 71.

The dash cross section 69 may be formed at a position corresponding to the upper open section 73 in the dash lower portion 61. The dash cross section 69 may be formed to protrude forward between the upper horizontal reinforcing rib 57 and the lower horizontal reinforcing rib 71.

The upper open section 73 may include 'X' shaped upper cross reinforcing ribs 79 connected to the upper transverse reinforcing rib 57 and the lower transverse reinforcing rib 71.

The upper cross reinforcing ribs 79 may be configured to reinforce the rigidity and/or strength of the upper open section 73.

The upper cross reinforcing ribs 79 may be arranged to extend along the width direction between the upper horizontal reinforcing rib 57 and the lower horizontal reinforcing rib 71. The upper cross reinforcing ribs 79 may be connected to each other.

The upper cross reinforcing ribs 79 may be formed on the rear surface of the dash cross section 69. The upper cross reinforcing ribs 79 may be connected to the dash upper reinforcing ribs 55 via the upper horizontal reinforcing rib 57.

For example, the upper cross reinforcing ribs 79 may be connected to the upper transverse reinforcing ribs 57 in the vertical direction via the connecting ribs 81. The upper transverse reinforcing ribs 57 may be connected to the dash upper reinforcing ribs 55 in the vertical direction.

The lower open section 75 may include dash lower reinforcing ribs 83 connected to the lower end 77 of the dash lower portion 61 and the lower transverse reinforcing ribs 71.

The dash lower reinforcing ribs 83 may be configured to reinforce the rigidity and/or strength of the lower open section 75.

The dash lower reinforcing ribs 83 may be arranged between the lower end 77 of the dash lower portion 61 and the lower horizontal reinforcing rib 71. The dash lower reinforcing ribs 83 may be formed on the rear surface of the lower open section 75 and may be connected to each other.

For example, the dash lower reinforcing ribs 83 may be provided in a form in which the unit ribs formed in the 'X' shape are connected in the width direction and the vertical direction. However, the present disclosure is not limited thereto, and the dash lower reinforcing ribs 83 may, for example, further include flat (e.g., straight) ribs connected along the width direction and/or the up-down direction to the unit ribs in the 'X' shape.

The lower open section 75 may include at least one floor joint forming portion 87 (e.g., at least one floor joint and/or surface comprising a floor joint) that is connectable to the front portion of the floor panel 85.

The at least one floor joint forming portion 87 may protrude upward from the lower surface of the lower open section 75.

The at least one floor joint forming portion 87 may be connected to the lower portion 77 of the dash lower portion 61. The at least one of the floor joint forming portions 87 may be connected to the dash lower reinforcing ribs 83.

In an example, the at least one floor joint forming portion 87 may be provided in multiple pieces. At least one such floor joint forming portion 87 may be joined to the front portion of the floor panel 85 by a mechanical joining and/or an aluminum welding, for example.

Forming reinforcing ribs 89 can be formed on the lower surface of at least one of the floor joint forming portions 87. The lower surface of at least one of the floor joint forming portions 87 may be defined as a concave surface upward from the lower surface of the lower open section 75.

The forming reinforcing ribs 89 may be configured to reinforce the joint rigidity and/or joint strength of the lower open section 75 and the floor panel 85, reinforce the torsional rigidity and/or bending rigidity of the lower open section 75, and form a load path that absorbs and distributes a front collision load.

The forming reinforcing ribs 89 may be configured as a one or more of a combination of, for example, 'X' shapes, 'V' shapes, and/or straight ribs in the width direction and/or upper-lower (e.g., /vertical) direction.

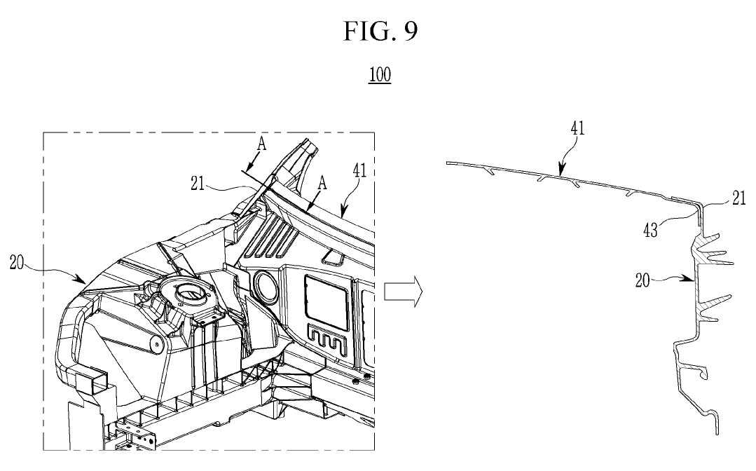

FIG. 9 is a cross-sectional view along line A-A of a front body structure according to the disclosed example.

Referring to FIG. 9, in the disclosed example, the front cowl 41 may be joined to the fender apron upper portion 21 of the fender apron member 20 in the front-rear direction of the vehicle body.

A cowl flange 43 may be formed at both ends of the front cowl 41 in the width direction.

The cowl flange 43 may be joined to an inner surface of the fender apron upper portion 21 in the front-rear direction of the vehicle body, for example, by a mechanical joining or an aluminum welding.

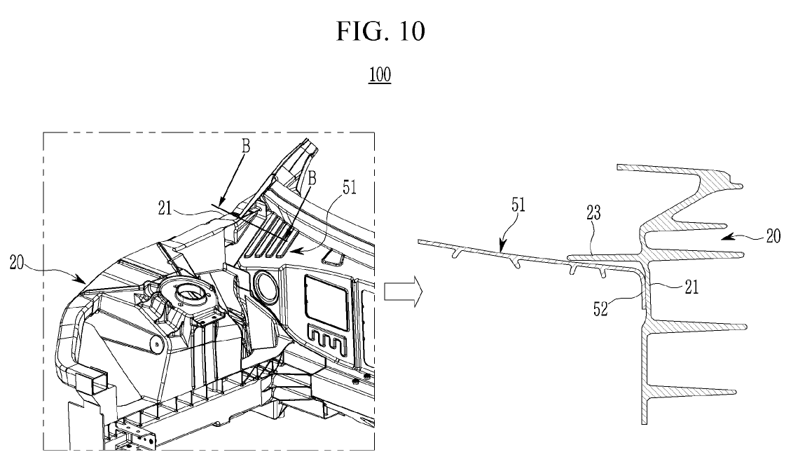

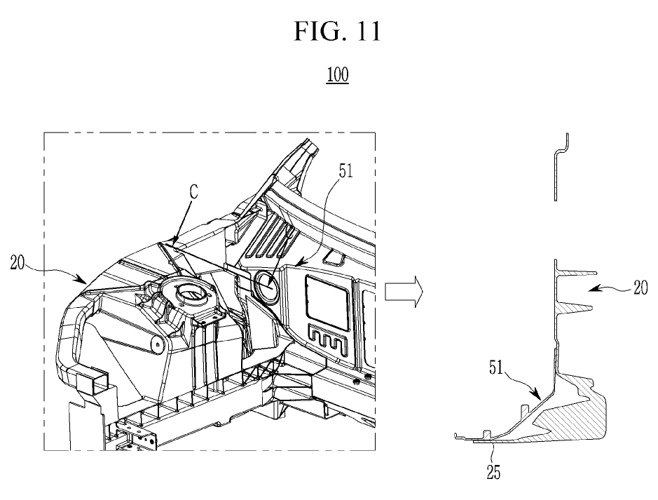

FIG. 10 is a cross-sectional view along line B-B of a front body structure according to the disclosed example, and FIG. 11 is a cross-sectional view along line C-C of a front body structure according to the disclosed example.

Referring to FIG. 10, in the disclosed example, the dash upper portion 51 may be joined to the fender apron upper portion 21 of the fender apron member 20 along the front-rear direction of the vehicle body.

A dash upper flange 52 may be formed at both ends of the dash upper portion 51 in the width direction.

The dash upper flange 52 may be joined to the inner surface of the fender apron upper portion 21 in the front-rear direction of the vehicle body by mechanical joining or aluminum welding.

Referring to FIGS. 10 and 11 , in the disclosed example, the dash upper portion 51 may be joined to the fender apron upper inner portion 23 (referring to FIG. 10) and the fender apron rear panel portion 25 (referring to FIG. 11) provided on the fender apron member 20 along the vehicle width direction.

For example, both ends of the dash upper portion 51 may be joined to the inner surface of the fender apron upper inner part 23 and the fender apron rear panel part 25 in the width direction by a mechanical joining method or aluminum welding.

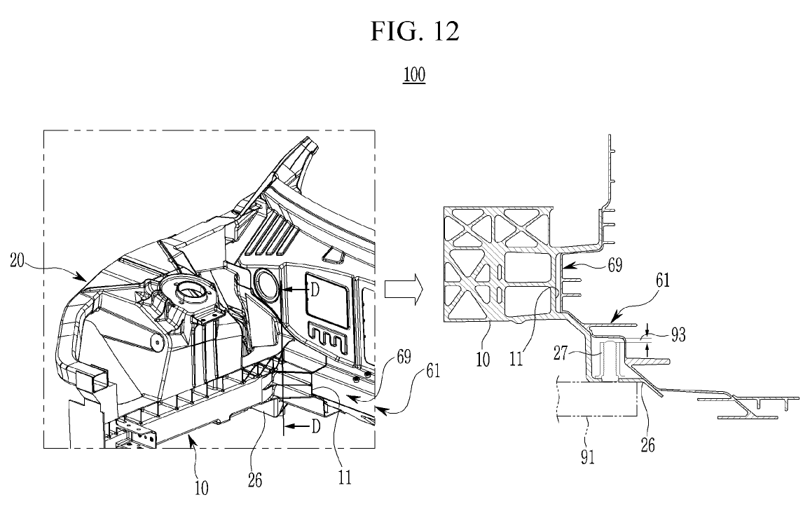

FIG. 12 is a cross-sectional view taken along line D-D of a front body structure according to the disclosed example.

Referring to FIG. 12, in the disclosed example, the dash cross section 69 of the dash lower portion 61 may be fitted into a groove-shaped fitting portion 11 formed in the inner portion of the front side member 10. As such, the dash cross section 69 may be joined to the fitting portion 11.

The dash cross section 69 may be joined to the fitting portion 11 in the up-down (e.g., vertical) direction and/or the front-rear direction of the vehicle body, for example, by a mechanical joining and/or an aluminum welding.

The dash lower portion 61 may be joined to the lower portion 26 of the fender apron member 20 by mechanical joining and/or aluminum welding, for example.

The dash lower portion 61 may be positioned with a gap 93 set between a mounting portion 27 provided on the lower portion 26 of the fender apron member 20 to mount the sub-frame 91.

The mounting portion 27 may comprise a weld nut and/or pipe nut welded to the lower portion 26 of the fender apron member 20. A fastening bolt (not shown) penetrating the sub-frame 91 may be fastened to the mounting portion 27.

Accordingly, since the dash lower portion 61 is positioned with the gap 93 set between the mounting portion 27 of the fender apron member 20, the fastening bolt does not penetrate the dash lower portion 61.

Since the dash lower portion 61 does not form a hole through which the fastening bolt penetrates, the front body structure 100 may secure the watertight performance of the dash lower portion 61.

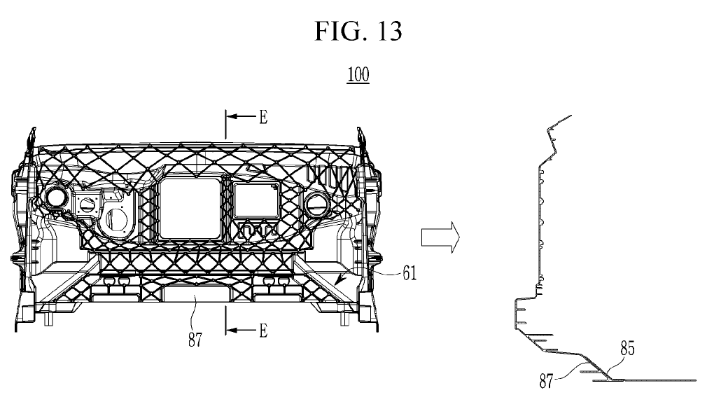

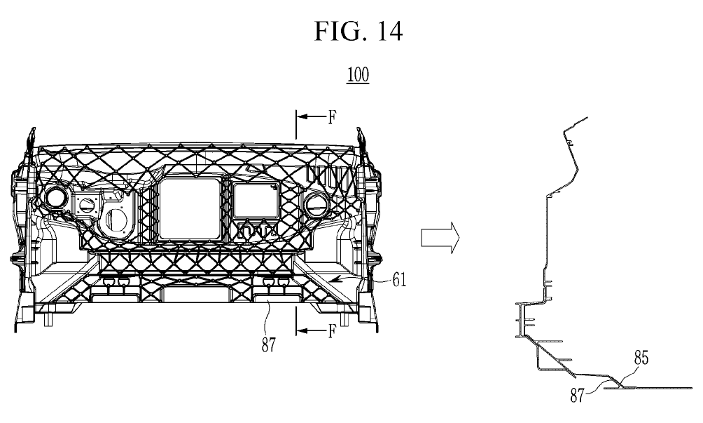

FIG. 13 is a cross-sectional view taken along a line E-E of a front body structure according to the disclosed example, and FIG. 14 is a cross-sectional view taken along a line F-F of a front body structure according to the disclosed example.

Referring to FIGS. 13 and 14, in the disclosed example, the dash lower portion 61 may be joined to the front portion of the floor panel 85 along the front-rear direction and the up-down direction of the vehicle body via at least one floor joint forming portion 87.

Here, the front part of the floor panel 85 may be joined to the upper surface of at least one floor joint forming portion 87 in the vertical direction, for example, by a mechanical joining method and/or aluminum welding.

The front part of the floor panel 85 may be joined along the front-rear direction of the vehicle body to a rear surface of at least one floor joint forming portion 87, for example, by a mechanical joining method and/or aluminum welding.

The front body structure 100 according to the disclosed example as described so far includes the integrated casting member 30 that integrates the dash panel 31 and the front cowl 41 by a hyper casting method, for example.

The front body structure 100 according to the disclosed example may reduce the number of the body parts, assembly man-hours, the weight, and the manufacturing cost by applying the integrated casting member 30.

According to the disclosed example, the front cowl 41 is integrally formed on the upper portion of the dash upper portion 51 of the dash panel 31, and the dash upper reinforcing ribs 55 are formed on the front cowl 41 and the dash upper portion 51 that are connected to each other.

Accordingly, the front body structure 100 according to the disclosed example may reinforce the rigidity and strength of the front cowl 41 supporting the front glass by the dash upper reinforcing ribs 55.

The front body structure 100 according to the disclosed example includes an upper open section 73 and a lower open section 75 each of which is divided into open sections on the rear surface of the dash lower portion 61 of the dash panel 31.

The front body structure 100 according to the disclosed example includes upper transverse reinforcing ribs 57, lower transverse reinforcing ribs 71, upper cross reinforcing ribs 79, and dash lower reinforcing ribs 83 that reinforce the rigidity and strength of the upper open section 73 and the lower open section 75.

Accordingly, the front body structure 100 according to the disclosed example may secure the predetermined rigidity and strength of the dash lower portion 61.

In addition, the front body structure 100 according to the disclosed example may secure the front collision performance of the front body by forming the load path that absorbs and distributes the load input to the front of the vehicle body along the up-down direction.

The front body structure 100 according to the disclosed example may absorb and distribute the load input to the front of the vehicle body along the width direction by the dash cross section 69 formed in the dash lower portion 61.

The front body structure 100 according to the disclosed example includes at least one floor joint forming portion 87 formed in the lower open section 75 and includes forming reinforcing ribs 89 formed in at least one floor joint forming portion 87.

Accordingly, the front body structure 100 according to the disclosed example may secure the joint rigidity and joint strength of the dash lower portion 61 and the floor panel 85 by the forming reinforcing ribs 89, and may secure the torsional rigidity and bending rigidity of the dash lower portion 61 and the floor panel 85.

The front body structure 100 according to the disclosed example may secure the front collision performance of the floor structure by forming the load path that absorbs and distributes the load input through the dash lower portion 61 and the floor panel 85 via the forming reinforcing ribs 89.

According to the front body structure 100 according to the disclosed example, the integrated casting member 30 may be joined to the front side member 10 and the fender apron member 20 along the front-rear direction of the vehicle body, the width direction, and the up-down direction.

Accordingly, the front body structure 100 according to the disclosed example may secure the connectivity of the front side member 10, the fender apron member 20, and the integrated casting member 30, and secure the rigidity of the front frame.

The present disclosure seeks to provide a front body structure having a relatively large body part formed by a hyper casting method.

A front vehicle body structure according to the disclosed example may include a front side member arranged along a front-rear direction of the vehicle body on both sides according to a vehicle width direction; a fender apron member connected to each of the front side members; and an integrated casting member joined to the front side member and the fender apron member, wherein the dash panel and the front cowl are formed in one body.

The front vehicle body structure according to the disclosed example, the integrated casting member is provided with an aluminum casting body.

The dash panel may include a dash upper portion to which a front cowl is connected along the width direction upward, and a dash lower portion connected to the lower portion of the dash upper portion.

The front vehicle body structure according to the disclosed example, at least one assembly mounting forming section may be formed in the dash upper portion.

The front vehicle body structure according to the disclosed example, the dash upper portion may include dash upper reinforcing ribs formed on the rear surface and connected to the front cowl.

The front vehicle body structure according to the disclosed example, a glass support member may be formed on the upper portion of the front cowl, and the glass support member may be connected to the dash upper member through the dash upper reinforcing ribs in the shape of an ‘X’.

The front vehicle body structure according to the disclosed example, the dash lower portion may include at least two open sections extending along the vertical direction on the rear surface.

The front vehicle body structure according to the disclosed example, the dash lower portion may include a first portion extending forward from the lower portion of the dash upper portion, a second portion extending downward from the first portion, and a third portion extending downwardly and slanting backward from the second portion.

The front vehicle body structure according to the disclosed example, the first portion, the second portion, and the third portion may be connected to the front side member along the width direction, and

The front vehicle body structure according to the disclosed example, the first portion and the second portion may be formed as a dash cross section arranged in the width direction.

The front vehicle body structure according to the disclosed example, the dash lower portion may include an upper open section connected to the dash upper portion, and a lower open section connected to the upper open section .

The front vehicle body structure according to the disclosed example, the dash upper portion may include an upper horizontal reinforcing rib formed along the width direction at the bottom, and

The front vehicle body structure according to the disclosed example, the dash lower portion may include a lower horizontal reinforcing rib formed along the width direction.

The front vehicle body structure according to the disclosed example, the upper open section may be formed between the upper transverse reinforcing rib and the lower transverse reinforcing rib.

The front vehicle body structure according to the disclosed example, the lower open section may be formed between the lower portion of the dash lower portion and the lower horizontal reinforcing rib.

The front vehicle body structure according to the disclosed example, the dash lower portion may include a dash cross section formed to protrude forward between the upper horizontal reinforcing rib and the lower horizontal reinforcing rib.

The upper open section may include 'X' shaped upper cross reinforcing ribs connected to the upper transverse reinforcing rib and the lower transverse reinforcing rib.

The front vehicle body structure according to the disclosed example, the lower open section may include dash lower reinforcing ribs connected to the lower portion of the dash lower portion and the lower transverse reinforcing ribs.

The front vehicle body structure according to the disclosed example, the lower open section may include at least one floor joint forming portion protruding upward from the lower surface so as to be joined to the floor panel, and

The front vehicle body structure according to the disclosed example, forming reinforcing ribs may be formed on the lower surface of at least one of the floor joint forming portions.

In the front body structure according to the disclosed example, the front cowl may be joined to the fender apron upper portion of the fender apron member along the front-rear direction of the body.

The front vehicle body structure according to the disclosed example, the dash upper portion may be joined to the fender apron upper portion of the fender apron member along the front-rear direction of the vehicle body and be joined to the fender apron upper inner part and the fender apron rear panel part provided on the fender apron member along the width direction of the vehicle.

In the front body structure according to the disclosed example, the dash lower portion may be joined to the front portion of the floor panel along the front-rear direction and the up-down direction of the vehicle body through at least one floor joining forming part.

The front vehicle body structure according to the disclosed example, the dash lower portion may be arranged with a predetermined gap for a mounting portion provided on the fender apron member for mounting a subframe.

While this disclosure describes certain examples, it is to be understood that the disclosure is not limited to the disclosed examples. To the contrary, the disclosure is intended to cover various modifications and equivalent arrangements included within the spirit and scope of the appended claims.

What is claimed is:

1. A front vehicle body structure of a vehicle body, the front vehicle body structure comprising:
a pair of front sides extending along a front-rear direction of the vehicle body and positioned on both sides of the front vehicle body structure in a vehicle width direction;
a pair of fender aprons, wherein each fender apron of the pair of fender aprons is connected to a corresponding front side of the pair of front sides; and
an integrated casting body comprising a dash panel and front cowl formed integrally, wherein the integrated casting body is joined to the front sides and the fender aprons.

2. The front vehicle body structure of claim 1, wherein:
the integrated casting body comprises an aluminum casting body.

3. The front vehicle body structure of claim 1, wherein:
the dash panel comprises:
a dash upper portion to which the front cowl is connected along an upper end in the vehicle width direction, and
a dash lower portion connected to a lower end of the dash upper portion.

4. The front vehicle body structure of claim 3, wherein:
at least one assembly mount support, configured to accept mounting of a dash component, is formed in the dash upper portion.

5. The front vehicle body structure of claim 3, wherein:
the dash upper portion comprises dash upper reinforcing ribs formed on a rear surface of the dash upper portion and connected to the front cowl.

6. The front vehicle body structure of claim 5, wherein:
a windshield support is formed on an upper portion of the front cowl, and
the windshield support is connected to the dash upper portion via the dash upper reinforcing ribs, wherein the dash upper reinforcing ribs form a shape of an ‘X’.

7. The front vehicle body structure of claim 3, wherein:
the dash lower portion comprises a rear surface forming at least two open sections divided into opened cross sections in a vertical direction.

8. The front vehicle body structure of claim 3, wherein:
the dash lower portion comprises:
a first portion extending forward from the lower end of the dash upper portion,
a second portion extending downward from the first portion, and
a third portion extending downward and rearward from the second portion.

9. The front vehicle body structure of claim 8, wherein:
sides of the first portion, the second portion, and the third portion in the vehicle width direction are each connected to a corresponding front side of the front sides, and
the first portion and the second portion form a dash cross section in the width direction.

10. The front vehicle body structure of claim 3, wherein:
the dash lower portion comprises:
an upper open section connected to the dash upper portion, and
a lower open section connected to the upper open section.

11. The front vehicle body structure of claim 10, wherein:
the dash upper portion comprises an upper horizontal reinforcing rib extending along the vehicle width direction, and
the dash lower portion comprises a lower horizontal reinforcing rib extending along the vehicle width direction.

12. The front vehicle body structure of claim 11, wherein:
the upper open section is formed between the upper horizontal reinforcing rib and the lower horizontal reinforcing rib, and
the lower open section is formed between the lower horizontal reinforcing rib and a lower end of the dash lower portion.

13. The front vehicle body structure of claim 11, wherein:
the dash lower portion comprises:
a dash cross section that protrudes forward between the upper horizontal reinforcing rib and the lower horizontal reinforcing rib.

14. The front vehicle body structure of claim 12, wherein:
the upper open section comprises 'X' shaped upper cross reinforcing ribs connected to the upper horizontal reinforcing rib and the lower horizontal reinforcing rib, and
the lower open section comprises dash lower reinforcing ribs connected to the lower horizontal reinforcing rib and the lower end of the dash lower portion.

15. The front vehicle body structure of claim 12, wherein:
the lower open section comprises at least one floor joint protruding upward from a lower surface of the dash lower portion, and configured to be joined to a floor panel, and
reinforcing ribs are formed on the at least one floor joint.

16. The front vehicle body structure of claim 3, wherein the dash upper portion is:
joined to an upper portion of each fender apron in the front-rear direction, and
joined to an inner side of a rear panel of each fender apron in the vehicle width direction.

17. The front vehicle body structure of claim 3, wherein:
the dash lower portion forms gaps configured to accept mounting portions, of the fender aprons, for mounting a subframe.

18. A front vehicle body structure comprising:
an integrated casting body comprising a dash panel and front cowl formed integrally;
a pair of front sides extending in a front-rear direction from either side of the integrated casting body in a width direction; and
a pair of fender aprons, wherein each fender apron of the pair of fender aprons is attached to a corresponding front side.

19. The front vehicle body structure of claim 18, further comprising:
reinforcing ribs formed on a rear surface of the dash panel and connected to the front cowl.

20. A vehicle comprising:
a front vehicle body structure comprising:
a pair of front sides extending along a front-rear direction of the vehicle and positioned on both sides of the front vehicle body structure in a vehicle width direction;
a pair of fender aprons, wherein each fender apron of the pair of fender aprons is connected to a corresponding front side of the pair of front sides; and
an integrated casting body comprising a dash panel and front cowl formed integrally, wherein the integrated casting body is joined to the front sides and the fender aprons.
